(19) United States
(12) Patent Application Publication
(10) Pub. No.: US 2018/0281158 A1
(43) Pub. Date: Oct. 4, 2018

(54) Object Placement and Fastening Aid

(71) Applicants: Ilyasullah Sayed Ebady, Lansdale, PA (US); Atiqullah Sayed Ebady, Lansdale, PA (US)

(72) Inventors: Ilyasullah Sayed Ebady, Lansdale, PA (US); Atiqullah Sayed Ebady, Lansdale, PA (US)

(21) Appl. No.: 15/476,104

(22) Filed: Mar. 31, 2017

(51) Int. Cl. B25B 11/02; E04F 21/00

(52) U.S. Cl. CPC B25B 11/02; E04F 2201/0505; E04F 2201/01; E04F 21/00

(57) ABSTRACT

A tool (FIG. 1) that assists in the placement and fastening together of pieces of material. The invention is comprised of valleys into which said pieces are placed. Said valleys have openings (portals) so that the exposed face of one piece can be aligned flush with the exposed face of another piece. The portals also allow an adequate means of fastening such as nails, screws, adhesive, etc. to be used to fasten them together at a predetermined angle. The invention may have multiple protruding valleys extending from a main valley, so that a base piece of material may have several pieces of material fastened to it—such as in framing the studs of a wall unit—without measuring distances or angles between pieces, thus saving considerable time, labor, and money.

### BACKGROUND

One of the most common tasks in construction, and carpentry in particular, is the placement and fastening together of pieces of material. In many cases, such as framing wall studs, the studs must be placed apart at standard distances, such as sixteen inches on center, and the pieces must be fastened perpendicular to one another. This task is often repeated many times over in a single project.

Certain tools, such as a measuring tape, have highlighted markings to assist in measuring industry standard distances, such as the standard distance between wall studs. However, these tools are limited to assisting in measurement only. They do not reduce the labor or skill required in many aspects of the placement and fastening tasks.

### SUMMARY

The invention assists in placing and fastening objects together at predetermined distances and angles by reducing the amount of skill and experience required to perform the task. The invention may be manufactured to predetermined angles and to accommodate various measurement standards, such as for standard distances between studs. The invention assists in securely holding said pieces in place for less strenuous fastening of said pieces, and saves time by eliminating steps that are common in the placement and fastening of said pieces.

The invention allows users that have minimal or no construction experience to perform tasks that require a significant amount of construction experience. Some advantages of the invention are:
(1) Reduces the knowledge, experience, expertise, and skills needed to place and fasten objects together at specific measurements and angles by eliminating tasks that require said skills.
(2) Eliminating tasks in the work process saves considerable time, labor, and money.
(3) Allows said objects of varying material composition to be placed together and fastened together with greater ease by providing a means for said objects to be held in place without the need for secondary tools or additional personnel assistance.
(4) Improves the flush joining of the surfaces of said pieces.
(5) Reduces human error across many aspects of the placement and fastening processes, such as measuring distances and aligning said pieces at specific angles.
(6) Allows objects to be securely held and fastened together at predetermined angles.
(7) Eliminates the need to measure distances between objects by allowing secure placement of dimensional objects at predetermined distances.

### DRAWINGS

FIG. 1 is a perspective top view of one variation of the invention, having a main valley 1 and a protruding valley 2 extending at a predetermined angle 3 from said main valley. Said main valley has an inner wall 4, an outer wall 5, and portals 6 and 7. Said protruding valley 2 has an inner wall 8 and an outer wall 9. The inner and outer walls rise vertically to a predetermined height and at a predetermined angle.

FIG. 2 is a perspective top view of another variation of the invention, having a main valley 10 and multiple protruding valleys 11 and 12 extending at a predetermined angle 13 from said main valley. Said main valley has an inner wall 14, an outer wall 15, and portals 16 and 17. Said protruding valley 11 has an inner wall 18 and an outer wall 19. Said protruding valley 12 has inner wall 20 and outer wall 21. The inner and outer walls rise vertically to a predetermined height and at a predetermined angle.

FIG. 3 is a perspective top view of another variation of the invention, having a main valley 22 and a protruding valley 23 extending at a predetermined angle 24 from said main valley. Said main valley has an inner wall 25. Said protruding valley 23 has an inner wall 26 and an outer wall 27. The inner and outer walls rise vertically to a predetermined height and at a predetermined angle.

FIG. 4 is an angular view of the variation of the invention shown in FIG. 1.

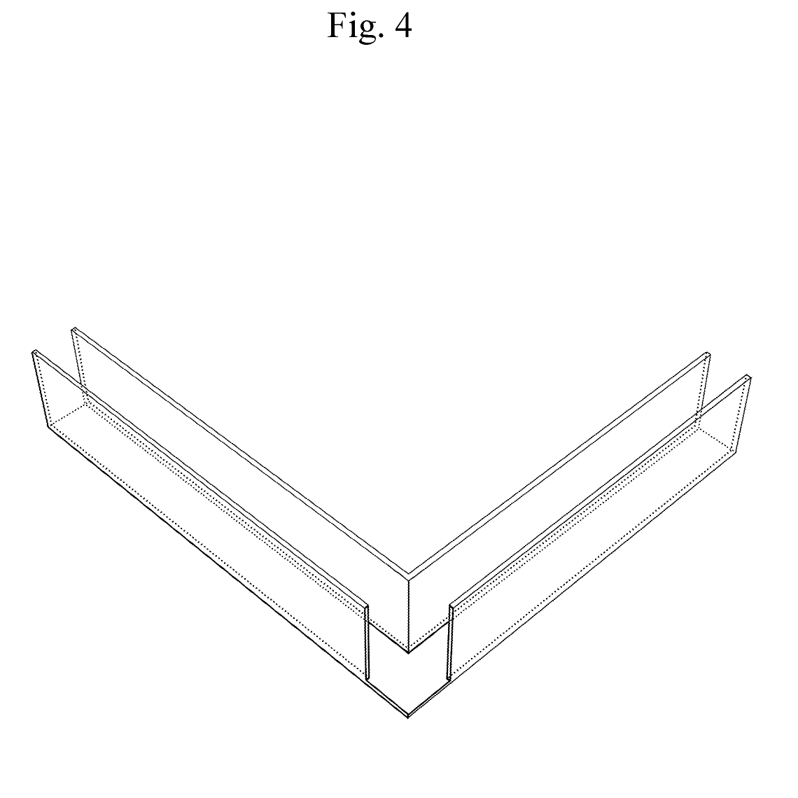

FIG. 5 is a perspective top view of another variation of the invention, having a protruding valley 29 extending at an acute angle 30 from the main valley 28.

FIG. 6 is an angular view of the variation of the invention shown in FIG. 5.

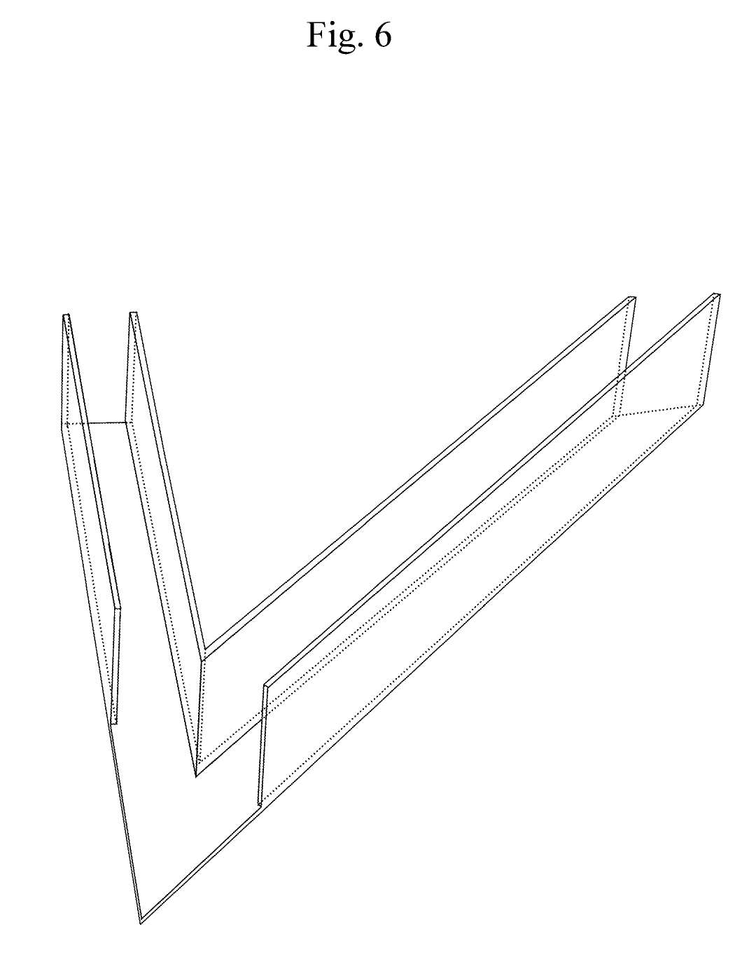

FIG. 7 shows cross-sections of two variations of valleys, one that is L-shaped 31, and one that is U-shaped 34.

FIG. 8 shows the invention being used in a common task of placing and fastening two pieces of material 38, 41. The first piece 38 is securely placed in the main valley 39. The second piece 41 is securely placed in the protruding valley 42 so that it is flush against said first piece 38. An adequate means of fastening, such as a nail 43 may be inserted at the portal 40 so that said nail penetrates through the first piece 38 and into the second piece 41.

### DESCRIPTION

The invention may be constructed from one or more pieces of material, and it may be composed of a single type of material, such as wood, plastic, metal, etc. or it may be a combination of said materials.

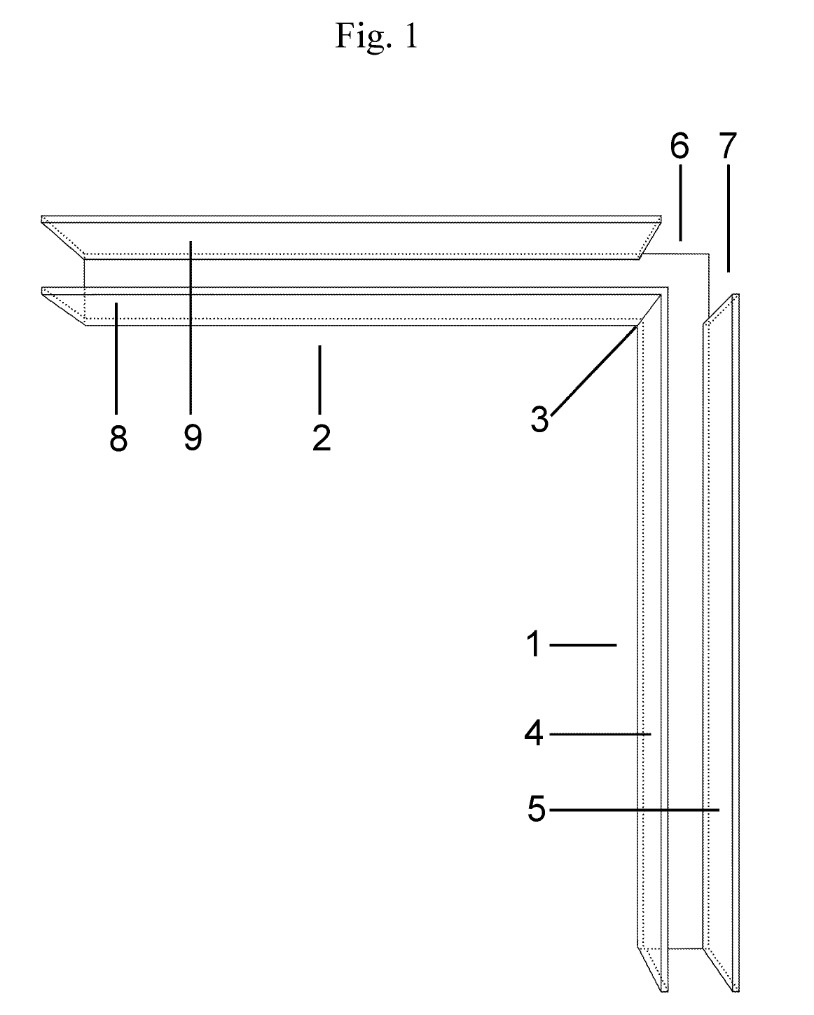

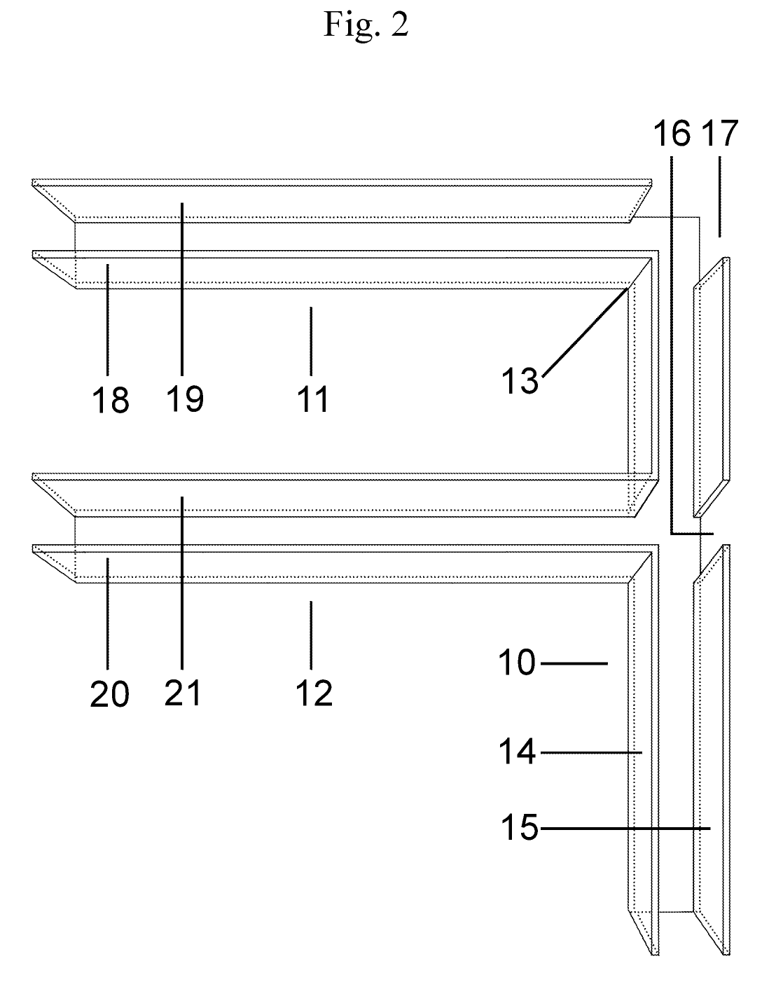

The invention may be comprised of at least one valley, said valley having at least one wall and at least one portal. When there are two valleys (FIG. 1), one shall be called the main valley 1 (FIG. 1), and the other is the protruding valley 2 (FIG. 1). When there are three or more valleys (FIG. 2), the main valley 10 (FIG. 2) shall be the valley from which other valleys 11, 12 (FIG. 2) extend out, and the valleys extending out from the main valley shall be called protruding valleys 11, 12 (FIG. 2). A protruding valley is such that its base is connected to the base of said main valley creating a vertex 13 (FIG. 2), and said protruding valley extends away from said main valley at a predetermined angle.

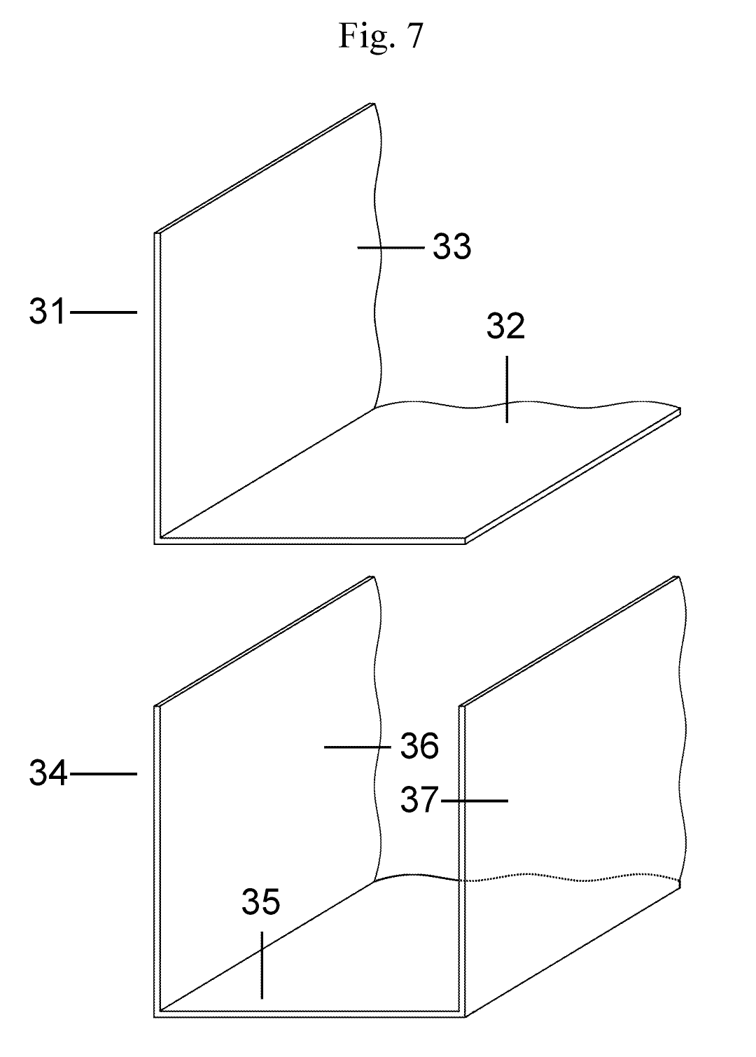

Each valley 31 (FIG. 7) is comprised of a base 32 (FIG. 7) and at least one wall 33 (FIG. 7) rising vertically from the base at a predetermined angle and to a predetermined height. When viewed at a cross-section, the valley would have an L-shape 31 (FIG. 7). A valley 34 (FIG. 7) may also be comprised of a base 35 (FIG. 7) and two walls 36, 37 (FIG. 7) rising vertically from either side of the base. In this variation of the invention, the valley would have a U-shape 34 (FIG. 7).

A portal 6, 7 (FIG. 1) is an open space in a wall or base of a valley. A portal 16, 17 (FIG. 2) may be located at any place along the length of a base or wall. A portal is primarily located along a wall of the main valley, and it is the opening that allows an adequate means of fastening, such as screws, nails, bolts, etc. to be driven horizontally through a base piece of material into a second piece of material in order to fasten said pieces together. Said screws, nails, bolts, etc. may also be inserted from any exposed face of said pieces of material.

### Operation

A first piece of material is placed in the main valley. A second piece of material is placed in a protruding valley. Said second piece is moved towards the vertex of the main valley and the protruding valley so that it rests flush against said first piece. Said first piece and said second piece may then be fastened together by various means, such as inserting a nail or screw through said first piece at the portal that is opposite to where said second piece is aligned with said first piece, said nail or screw being of sufficient length to fasten said first piece to said second piece. If the variation of the invention has multiple protruding valleys (FIG. 2), then additional pieces of material may be similarly fastened to said first piece at the additional protruding valleys. If the variation of the invention has only one protruding valley, then said pieces may be removed from the invention, and the invention may be secured at another location along the first piece to fasten additional pieces of material to said first piece.

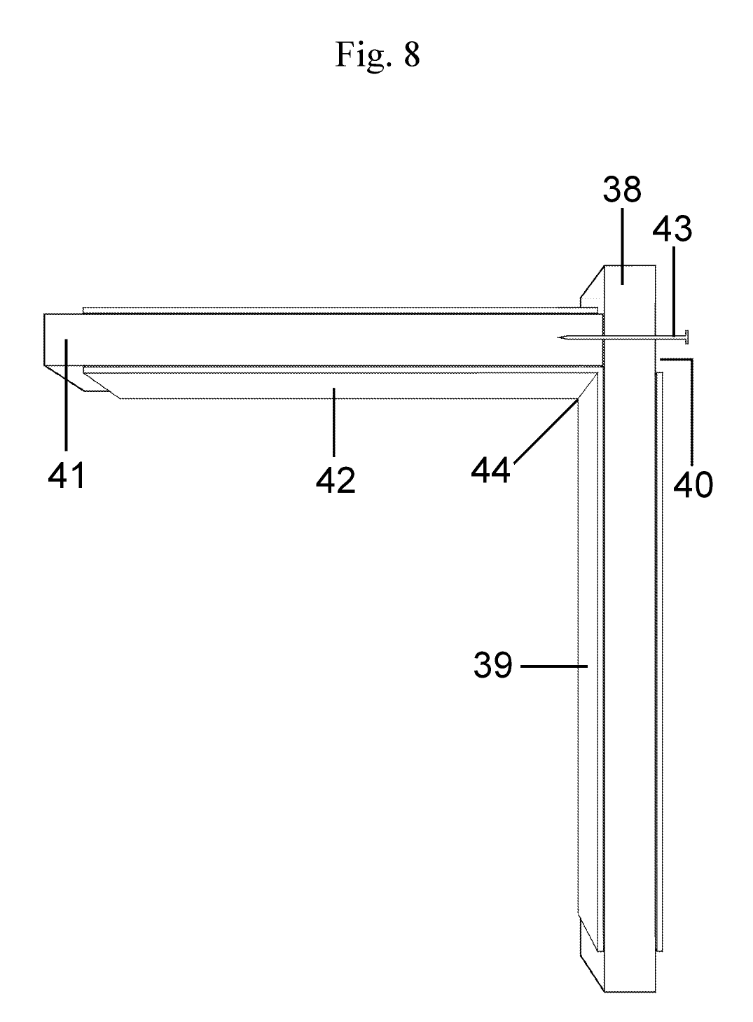

In one variation of the invention (FIG. 8), a first piece of lumber 38 (FIG. 8) is placed in the main valley 39 (FIG. 8) so that one end of said first piece covers the portal 40 (FIG. 8). A second piece of lumber 41 (FIG. 8) is then placed in the protruding valley 42 (FIG. 8) and moved horizontally towards vertex 44 (FIG. 8) so that one end of said second piece 41 rests flush against said first piece 38. An adequate means of fastening, such as a nail, screw, etc. 43 (FIG. 8) is then inserted into said first piece 38 at said portal 40, said nail or screw 43 being of sufficient length to penetrate said first piece 38 and penetrate through to said second piece 41, thus fastening said pieces together. Additional screws may be inserted through said first piece 38 in similar fashion.

In another variation of the invention (FIG. 2), additional protruding valleys 11, 12 (FIG. 2) may be spaced sixteen inches apart on-center. A first piece of lumber may be placed in the main valley 10 (FIG. 2) so that it covers both portals 16, 17 (FIG. 2). A second piece of lumber may be placed in the first protruding valley 11 (FIG. 2) so that it is flush against said first piece and fastened to said first piece at the portal 17 (FIG. 2). When a third piece of dimensional lumber is placed in the other protruding valley 12 (FIG. 2) and fastened to said first piece at the portal 16 (FIG. 2), said second piece and said third piece shall be sixteen inches apart on-center. If the standard distance between studs were to be sixteen inches, this variation of the invention may be used to frame studs without measuring angles or distances, thus saving considerable time, labor, and money.

### REFERENCE NUMERALS

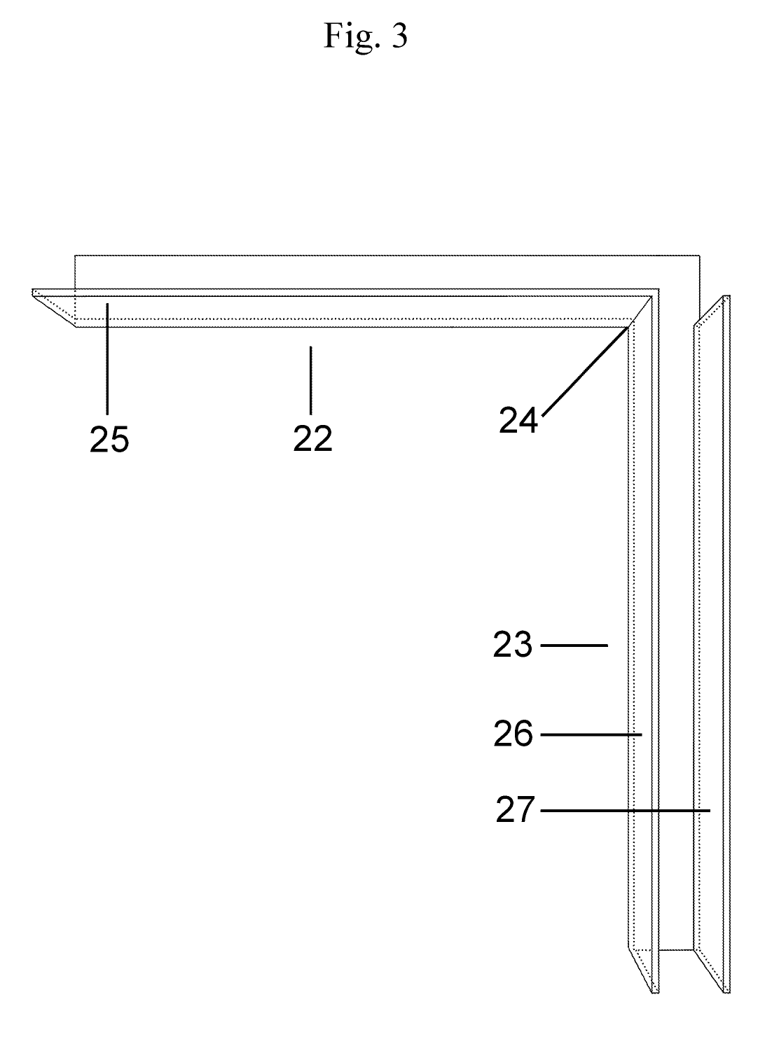

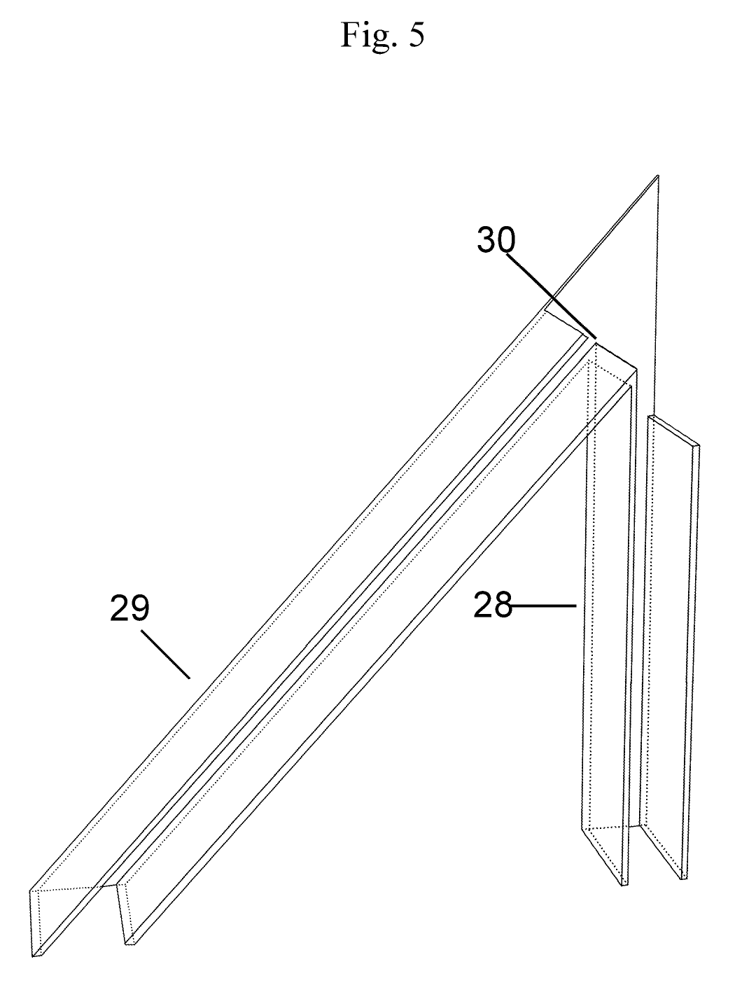

1 Main valley in FIG. 1
2 Protruding valley in FIG. 1
3 Vertex of main valley and protruding valley in FIG. 1
4 Inner wall of main valley in FIG. 1
5 Outer wall of main valley in FIG. 1
6 Fastening portal in FIG. 1
7 Fastening portal in FIG. 1
8 Inner wall of protruding valley in FIG. 1
9 Outer wall of protruding valley in FIG. 1
10 Main valley in FIG. 2
11 First protruding valley in FIG. 2
12 Second protruding valley in FIG. 2
13 Vertex of main valley and first protruding valley in FIG. 2
14 Inner wall of main valley in FIG. 2
15 Outer wall of main valley in FIG. 2
16 Second portal in FIG. 2
17 First portal in FIG. 2
18 Inner wall of first protruding valley in FIG. 2
19 Outer wall of first protruding valley in FIG. 2
20 Inner wall of second protruding valley in FIG. 2
21 Outer wall of second protruding valley in FIG. 2
22 Main valley in FIG. 3
23 Protruding valley in FIG. 3
24 Vertex of main valley and protruding valley in FIG. 3
25 Inner wall of main valley in FIG. 3
26 Inner wall of protruding valley in FIG. 3
27 Outer wall of protruding valley in FIG. 3
28 Main valley in FIG. 5
29 Protruding valley in FIG. 5
30 Vertex of main valley and protruding valley in FIG. 5
31 Cross-section of L-shaped valley in FIG. 7
32 Base of L-shaped valley in FIG. 7
33 Wall of L-shaped valley in FIG. 7
34 Cross-section of U-shaped valley in FIG. 7
35 Base of U-shaped valley in FIG. 7
36 One wall of U-shaped valley in FIG. 7
37 Other wall of U-shaped valley in FIG. 7
38 Main piece in FIG. 8
39 Main valley in FIG. 8
40 Portal in FIG. 8
41 Second piece in FIG. 8
42 Protruding valley in FIG. 8
43 An adequate means of fastening, such as a nail, screw, bolt, etc.
44 Vertex of main valley and protruding valley in FIG. 8

1. A device for aiding in tasks that require placing objects together, and comprising:
A composition of rigid material such as wood, metal, plastic, etc. or a combination of said materials
Said material being of predetermined thickness,
A main valley having a base of predetermined length and width (FIG. 1),
Said main valley having one or more walls of predetermined length rising vertically from the sides of said base up to predetermined heights and at predetermined angles,
Said walls may have openings of predetermined dimensions at predetermined locations along the wall,
Zero, one or more protruding valleys extending away from said main valley at predetermined angles,
Said protruding valleys extending from said main valley at predetermined locations along said main valley,
Said protruding valleys each having a base of predetermined length and width,
Said protruding valleys each having at least one wall of predetermined length rising vertically from the sides of the bases of said protruding valleys up to predetermined heights and predetermined angles,
Said walls of protruding valleys may have openings of predetermined dimensions at predetermined locations,
Whereby (a) a person can use said device to securely hold pieces of material in place so that said pieces can be fastened together with less effort, (b) the protruding valleys are at predetermined locations along the main valley to eliminate measuring distances between pieces of material, (c) the protruding valleys extend from the main valley at predetermined angles to eliminate measuring angles and using secondary means to hold objects at said angles.
